(19) United States
(12) Patent Application Publication
(10) Pub. No.: US 2009/0311157 A1
(43) Pub. Date: Dec. 17, 2009

(54) NUCLEOPHILIC RADIOFLUORINATION USING MICROFABRICATED DEVICES

(76) Inventors: Colin Steel, London (GB); Robin Fortt, London (GB); Elaine Liow, London (GB); Stefan Riese, Muenster (DE)

Correspondence Address: GE HEALTHCARE, INC., IP DEPARTMENT 101 CARNEGIE CENTER, PRINCETON, NJ, 08540-6231, US

(21) Appl. No.: 12/519,816

(22) PCT Filed: Dec. 20, 2007
(86) PCT No.: PCT/US07/88363

§ 371 Date: Jun. 18, 2009

Related U.S. Application Data
(60) Provisional application No. 60/871,210, filed on Dec. 21, 2006.
(60) Provisional application No. 60/886,985, filed on Jan. 29, 2007.
(60) Provisional application No. 60/914,952, filed on Apr. 30, 2007.

(51) Int. Cl. C01B 7/20; B01J 4/00; B01J 19/00

(52) U.S. Cl. 423/249; 422/255; 422/187; 422/224

(57) ABSTRACT

A microscale solution for conducting [¹⁸F]fluoride phase transfer and subsequent radiosynthesis of 2-[¹⁸F]FDG that eliminates the azeotropic drying process. [¹⁸F]fluoride phase transfer is performed using an inexpensive disposable microchip. Additionally, each subsequent each step may be performed on the same single microchip.

### FIELD OF THE INVENTION

The present invention relates to the field of radiotracer synthesis. More specifically, the present invention is directed to PET radiotracer synthesis using microstructures.

### BACKGROUND OF THE INVENTION

Microfluidic devices offer several significant benefits for PET radiotracer synthesis including reduced radiation shielding requirement, smarter reaction times, increased control of reaction conditions and reduced reagent consumption. Radiotracer synthesis may be broadly described as requiring four steps, Trapping/Phase-Transfer, Labelling, Deprotection, and Purification. Several authors have previously reported the use of microfluidic devices for the radiosynthesis of 2-[18F]FDG where the radiolabelling and deprotection reactions were performed using simple microfluidic ‘T’-mixers. However to date, as described below, only one group has reported the more challenging [18F]fluoride phase transfer process by utilizing a circulation system with many valves, and it has been demonstrated to work with a radioactivity sufficient for small animal PET scans (720 μCi 18F−).

The typical ¹⁸F-fluoride phase transfer method utilizes a phase transfer resin. The ¹⁸F-fluoride carrying water is pushed through a cartridge packed with suitable resin beads. While the water passes through the resin the ¹⁸F-fluoride is trapped. The ¹⁸F-fluoride is then washed out of the resin by flushing it with an eluent consisting of water, potassium carbonate (K₂CO₃), acetonitrile (McCN) and Kryptofix® as phase transfer catalyst. The resulting ¹⁸F-fluoride is not water-free since water is required in order to dissolve the potassium carbonate. The latter is required to introduce K⁺-ions acting as counter ions for the ¹⁸F⁻-ions. Usual eluent compositions contain acetonitrile and between 20% and 73% of water. But for the subsequent labeling reaction the presence of water is generally avoided since the polar water molecules shield the ¹⁸F⁻ ions by hydration thereby shielding them from a nucleophilic attack. In order to gain reactive “naked” ¹⁸F-fluoride ions the solution is usually dried by azeotropic distillation. So the phase transfer can be divided into, first, Solvent Exchange and, second, Additional drying.

Known methods for performing Solvent Exchange include the methods of Solid Phase Extraction (SPE), Electrode method, and Electrodialysis. In SPE, ¹⁸F-fluoride is trapped by resin beads and afterwards eluted from the resin. The method is well established and efficient and should be easy to implement on microchips. However, filling of beads into the microstructures of the chips is a challenge and the need for additional drying step may be expected. In the Electrode method, ¹⁸F⁻-ions are captured by a positive electrode. After solvent exchange they are released by reversing the voltage. While the additional drying step will not be required, such a method is, technically, too complex for economical implementation on a microstructures. In Electrodialysis, Water carrying ¹⁸F⁻-ions passes along a hydrophobic membrane. The volume on the other side of the membrane is filled with acetonitrile. Water cannot penetrate the membrane but ¹⁸F⁻-ions are forced by an electric field to migrate through the membrane into the acetonitrile. Since the ions can be transferred into dry acetonitrile the additional drying step might not be required if water permeability of the membrane is low enough. However, Electrodialysis on a microchip has not been demonstrated.

The most common method for the Additional drying step is azeotropic distillation. As acetonitrile forms an azeotrope with water it is possible to dry the ¹⁸F-fluoride by evaporation of the acetonitrile-water mixture by heating under vacuum. This step has been implemented on a microchip by the UCLA/Siemens group and is so far the only published method for implementing step 1 on a microchip. This method utilizes a quite complicated microstructure design, shown in FIG. 1, with up to 40 active micro valves and up to 9 peristaltic pumping valve groups. Azeotropic drying is performed by evaporation of the solvent through a gas-permeable poly(dimethylsiloxane) (PDMS) matrix. A limitation is that PDMS is not compatible with most organic solvents and might cause problems with leachables.

The most commonly used process for synthesis of [¹⁸F]FDG, is that of Hamacher et al, J. Nucl. Med. 27:235-238 (1986) in which the reaction of 1,3,4,6-tetra-O-acetyl-2-O-trifluoromethanesulfonyl-β-D-mannopyranose with [¹⁸F]fluoride is performed in anhydrous solvent. More recently, fluoridation processes, including for synthesis of [¹⁸F]FDG where controlled amounts of water are present in the solvent have been described in WO 2006/054098.

The prior art fluorination system 10 includes many components for providing a ‘dry’ ¹⁸F-fluoride to a microfluidic device 12 for mixing with a precursor for labeling. System 10 employs a six-port liquid chromatography loop inject valve 14 in which a sep-pak cartridge 16 has been substituted for the loop. The ¹⁸F-fluoride is provided into an input port of valve 14. The output from valve 14 is directed to a four-port select valve 18. K₂CO₃/K222 eluent is provided from a source reservoir 20 under the force of helium provided and controlled by a regulator 22, pressure gauge 24, and flow meter 26. lastly, needle valve 28 directs the helium to force the eluent towards valve 14 for mixing with the ¹⁸F-fluoride in sep-pak cartridge 16. CH₃CN is provided from a reservoir 30, also under helium pressure through needle valve 32 towards valve 18. Helium pressure is also separately provided to valve 18 through needle valve 34. The eluate from sep-pak 16 is mixed with the CH₃CN and directed to the drying vessel 36 set within a beater 38 for conventional heating and drying. The ‘dried’ ¹⁸F-fluoride is then directed by pump 40 towards microfluidic device 12.

Microfluidic device 12 defines an input port 42, an output port 44, and an elongate microfluidic channel 46 extending in fluid communication therebetween. Input port 42 is placed in fluid communication with the output line 48 of pump 40 and with the output line 49 from a precursor reservoir 50. The precursor (eg, triflate) is provided by reservoir 50 by a pump 52 to begin mixing with the ¹⁸F-fluoride at input port 42. Channel 46 includes a first serpentine pathway 54 and a second serpentine pathway 56. First serpentine pathway 54 is the portion of channel 46 in which the labeling reaction occurs. Device 12 further defines a second input port 58 provided in fluid communication with channel 46 at a location between first and second serpentine pathways 54 and 56. Second input port 58 is also provided in fluid communication with a reservoir 55 of NaOH. Pump 60 directs the NaOH through output line 59 into channel 46 for mixing with the labeled ¹⁸F-fluoride mixture in second serpentine pathway 56 and thus provides for deprotection. All of the fluids are directed through device 12 under the pressure of pumps 40, 52, and 60 so that the resultant mixture is directed out from output port 44 and through a conduit 62 to a pair of sep-pak cartrides 64 and 66 for purification.

The overall design of this system is probably too expensive for a disposable chip. So azeotropic drying remains a challenge for microfluidic synthesis.

There is therefore a need for an inexpensive, high capacity microscale solution for conducting [18F]fluoride phase transfer that eliminates the azeotropic drying process. Additionally, there is a need for devices and methods enabling each step of the radiosynthesis process using microchips.

### BRIEF DESCRIPTION OF THE FIGURES

FIG. 1 shows a schematic example of an MFD based nucleophilic [F-18]fluorination system combined with conventional drying apparatus of the prior art.

FIG. 2 shows a simplified MFD based nucleophilic [F-18]fluorination system incorporating nanopaks of the present invention.

FIG. 3 shows a cross-sectional view of a nanopak of the present invention.

FIG. 4 depicts six microchips of the present invention.

FIG. 5 depicts the crowding effect employed in microstructures which do not employ weirs to retain resin particles.

FIG. 6 depicts a COC microchip of the present invention for performing the trapping and/or purifying steps.

FIG. 7 depicts an alternative microchip of the present invention for labeling and deprotecting.

FIG. 8 depicts an alternative microchip of the present invention for receiving eluted 18F and then conducting labeling and deprotecting steps.

FIG. 9 shows a chart depicting Radiochemical purity using different water content during labeling.

FIG. 10 show the results of 35 experiments of trapping of [18F]Fluoride (1 ml) on PS-HCO3.

FIG. 11 charts the results of the Elution of trapped ¹⁸F when using eluents with different water content.

FIG. 12 depicts the layout of the Syrris mixer chip used in experiments.

FIG. 13 depicts a schematic diagram of the experimental set-up for demonstrating synthesis on a chip.

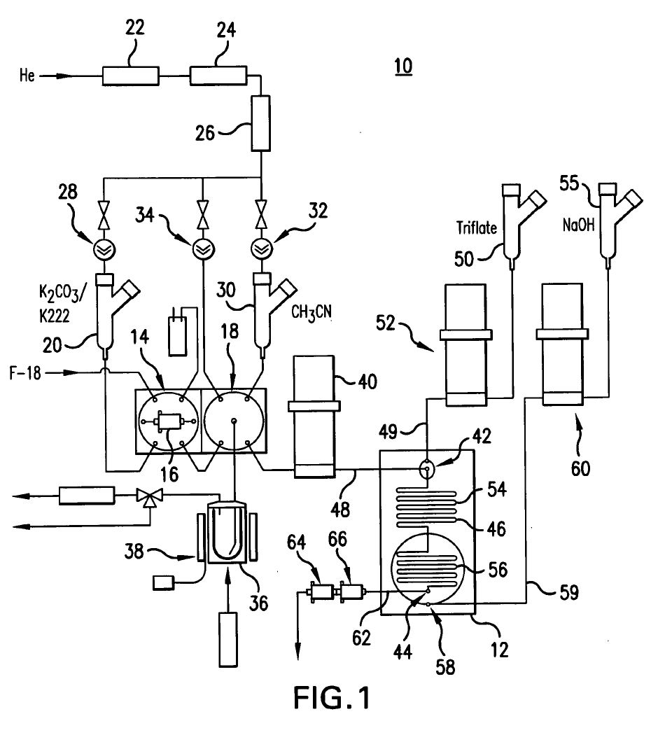

### DETAILED DESCRIPTION OF THE PREFERRED EMBODIMENTS

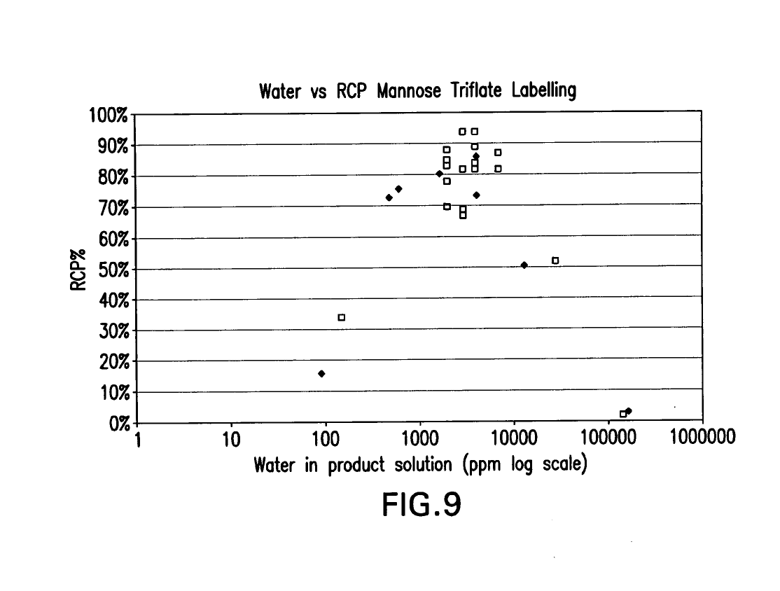

The present invention contemplates two alternative approaches for, either by avoiding the need of additional drying after the phase transfer or by an alternative drying method. It is generally believed that the fluoride ion has to be “naked” (i.e., not hydrated) in order to achieve efficient nucleophilic substitution and for this reason it is common to include a time consuming azeotropic drying step. However, as disclosed by WO 2006/054098 and shown in FIG. 9, a detailed analysis synthesis of FDG in acetonitrile has revealed that some water content is acceptable, and a water content of 0.1% to 0.7% is even beneficial compared to a completely dry reaction solution. Therefore, the present invention provides Elute-trapped 18F− with an eluent containing the minimum water necessary for elution. The present invention adjusts the water content of the reaction solution to 0.5% by adding acetonitrile with the dissolved precursor.

The present invention also provides devices for performing the trapping step. In one embodiment, the device of the present invention is a nanopak, an elongate tube having a volume of about 1-15 μL. Alternatively, the present invention provides microchip structures which may perform the trapping step such that the elution may be further used in the radiotracer synthesis process. The present invention contemplates that the trapping and elution step may be performed in a nanopak or microchip separate from the microchip where the labeling and deprotection steps occur. Alternatively, the present invention contemplates a single microchip for performing the trapping, labeling, and deprotecting steps. Additionally, a single microchip may be provided for performing all four of the major steps of radiotracer synthesis.

In order to avoid the need for a separate dying step either the phase transfer method may be modified to deliver a “dry enough” solution or the labeling method may be modified to accept more water in the reaction mixture.

The Electrode phase transfer method requires only rinsing the 18F-fluoride carrying electrode with an organic solvent but no azeotropic drying. It was found to be too challenging for economical implementation on a microstructure. The published successful method utilizes a glassy carbon vessel with a platinum electrode. A simpler implementation has been tested by the inventors before this study.

An alternative labeling method has been published by Kim et al applying the usual SPE phase transfer method and a reaction solvent that contains an ionic liquid (1-butyl-3-methylimidazolium trifluoromethanesulfonate). This method is highly water tolerant and allows labeling without previous drying. Preliminary experiments in the Hammersmith lab revealed that this ionic liquid is too viscous to be used in our microstructures due to prohibitively high backpressures.

The present invention discloses that the “classical” SPE phase transfer method may be used without further drying with only a slight modification. It was demonstrated in WO2006/054098 that a completely water free solution is not required for FDG synthesis, and that controlled amounts of water in the solvent can result in improved radiochemical purity of the product.

As it is possible to elute the ¹⁸F-fluoride trapped on resin beads by a liquid that contains less then 0.7% water the present invention also demonstrates that it is possible to use the resin phase transfer without subsequent drying.

The eluent is suitably selected from a potassium salt (such as potassium carbonate, potassium bicarbonate, or potassium sulphate) optionally in the presence of a phase transfer catalyst such as Kryptofix; a tetraalkylammonium salt (such as tetraalkylammonium carbonate, tetralkylammonium bicarbonate, or tetraalkylammonium sulphate); and a cesium salt (such as cesium carbonate, cesium bicarbonate, or cesium sulphate); provided in a solution comprising organic solvent (suitably selected from acetonitrile, dimethylformamide, dimethylsulfoxide, tetrahydrofuran, dioxan, 1,2-dimethoxyethane, sulfolane or N-methylpyrrolidinone or a mixture of any thereof), water, or an organic solvent containing water. Suitably, the solution is formed in a dry organic solvent (i.e. containing less than 1000 ppm water), or an organic solvent containing water at a level which is tolerated in the subsequent radiofluoridation reaction, for example 1000 ppm to 50,000 ppm water, preferably 1000 to 15,000 ppm, more preferably 2000 ppm to 7000 ppm, suitably 2500 ppm to 5000 ppm, as is taught in WO 2006/054098. In this way, a further drying step before radiofluoridation may be avoided. In one embodiment, the eluent is potassium carbonate and a phase transfer catalyst such as Kryptofix in acetonitrile or acetonitrile/water mixture.

Moreover, the method of the present invention has the benefit that the same SPE technology can also be used for final purification. Once SPE phase transfer has been implemented on microstructures, implementation of SPE purification is relatively straight-forward.

The method of the present invention further has the advantage that a separate mixer structure is not required thereby simplifying the microstructure design

Elution and trapping experiments were performed with 1 mL of irradiated ¹⁸O/water. The amount of resin must be sufficient to trap not only the ¹⁸F-fluoride but all other anions that are dissolved in the irradiated water; they exceed the fluoride by far. An analysis of irradiated water from the literature allows an estimation of the anion concentration as 261 μmol/L. Since the anion concentration may vary due to target construction, water quality, target history and other factors a safety factor of 2 is used.

The PS-HCO3 resin from Macherey-Nagel has an anion capacity of 0.75 mcq/g. The density of the resin has been determined to 0.45 g/mL. From the above data a required resin volume of 0.3 μL is calculated for 1 mL of ¹⁸F-fluoride solution. Since it is known from experience with TRACERlab FX, sold by GE Healthcare of Little Chalfont, U.K., that going down to the theoretically required resin reduces the overall yield and because the resin beads may probably not be packed in microstructures as densely as in commercial SPE cartridges, microstructures were prepared for higher volumes of resin (1 μL to 15 μL).

An [¹⁸F]fluoride solution produced by the method of the invention may subsequently be used in a [¹⁸F]radiotracer synthesis, to perform nucleophilic [¹⁸F]fluoridation of a labelling precursor to form an [¹⁸F]radiotracer.

As used herein, the term “labelling precursor” means a biomolecule suitable for radiolabelling to form an [¹⁸F]radiotracer, such as a peptide, protein, hormone, polysaccaride, oligonucleotide, antibody fragment, cell, bacterium, virus, or small drug-like molecule. In one embodiment, the labelling precursor is mannose triflate which may be used to prepare [¹⁸F]FDG.

The reaction of a labelling precursor with an [¹⁸F]fluoride solution produced by the method of the invention may be effected at an elevated temperature, for example up to 200° C. or at non-extreme temperature, such as 10° C. to 50° C., and most preferably at ambient temperature. The temperature and other conditions for radiofluoridation being selected according to the exact reaction being performed, nature of reaction vessel, solvents etc as would be apparent to a person skilled in the art.

Following [¹⁸F]fluoridation, a purification step may be required which may comprise, for example, removal of excess [¹⁸F]fluoride, removal of solvent, and/or separation from unreacted labelling precursor. Excess [¹⁸F]fluoride may be removed by conventional techniques such as ion-exchange chromatography (for example using BIO-RAD AG 1-X8 or Waters QMA) or solid-phase extraction (for example, using alumina). Excess solvents may be removed by conventional techniques such as evaporation at elevated temperature in vacuo or by passing a stream of inert gas (for example, nitrogen or argon) over the solution. Alternatively, the [¹⁸F]radiotracer may be trapped on a solid-phase, for example a cartridge of reverse-phase absorbant for example a C₅₋₁₈ derivatized silica, whilst the unwanted excess reagents and by-products are eluted, and then the [¹⁸F]radiotracer may be eluted from the solid-phase in purified form. In one embodiment, purification of the [¹⁸F]radiotracer is performed in a microfluidic device.

### Nanopaks

As the development of microchips is time consuming and the resin volume is fixed for each design, a simpler approach was developed for first experiments, the so-called “Nanopak” tubes. The objective of the Nanopak microstructure was to create a test vehicle that was easy to pack with resin, easy to interface with, macroscale and microscale apparatus, and facilitated exploration of microfluidic solid phase extraction of ¹⁸F Fluoride from ¹⁸O water, using resin volumes in the 1-25 μl range. The Nanopak consisted of a length of ⅛″ or 1/16″ Teflon tubing, packed with a volume of resin for solid phase extraction, and interfaced through finger tight flangeless HPLC fittings.

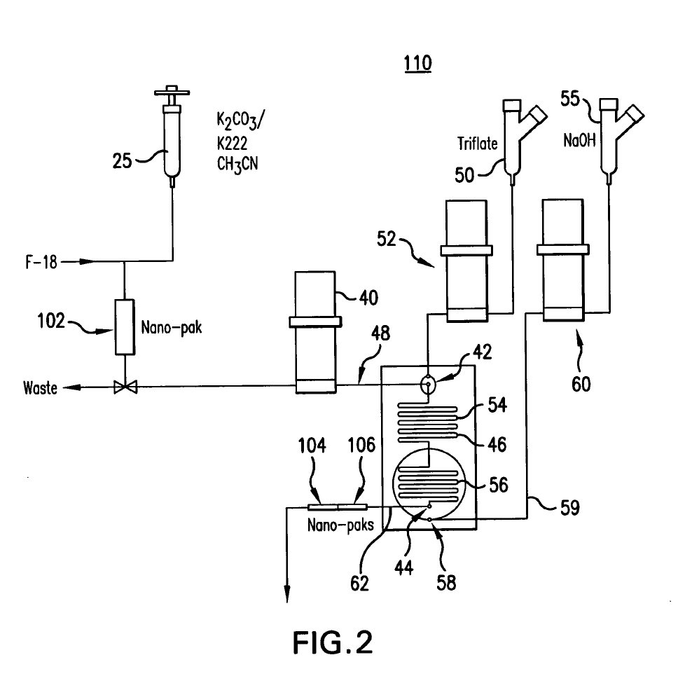

The resin was Chromabond PS-HCO3, specified as 60 μm diameter [d50=(60±15) μm, d95/d5: 2.5±1] by Macherey Nagel. Experimental observations showed the actual bead size distribution to vary from 19 to 113 μm diameter as determined by examining a random sample of 42 beads under a microscope. This resin was also used for the glass, PMMA, and cycloolefin copolymer (COC) devices. FIG. 2 depicts a radiotracer synthesis system 110 employing a nanopak both for the trapping step and for the purification step of the process as described hereinbelow.

The ¹⁸F-fluoride from a cyclotron and the eluent from reservoir 25 is provided to nanopak 102 for trapping of the 18F. Because the need for azeotropic drying is now obviated, the output from nanopak 102 includes an acceptable amount of water to continue directly on to labeling. The eluate output from nanopak 102 is directed towards microfluidic device 12 as previously described.

Microfluidic device 12 defines an input port 42, an output port 44, and an elongate microfluidic channel 46 extending in fluid communication therebetween. Input port 42 is placed in fluid communication with the output line 48 of pump 40 and with the output line 49 from a precursor reservoir 50. The precursor (eg, triflate) is provided by reservoir 50 by a pump 52 to begin mixing with the ¹⁸F-fluoride at input port 42. Channel 46 includes a first serpentine pathway 54 and a second serpentine pathway 56. First serpentine pathway 54 is the portion of channel 46 in which the labeling reaction occurs. Pump 60 may direct NaOH through output line 59 into channel 46 for mixing with the labeled ¹⁸F-fluoride mixture in second serpentine pathway 56 and thus provides for deprotection, should this step be required. All of the fluids are still directed through device 12 under the pressure of pumps 40, 52, and 60 so that the resultant mixture is directed out from output port 44 and through a conduit 62 to a pair of nanopak cartrides 104 and 106 for purification. The present invention further contemplates that each pump and reservoir combination may further comprise a syringe pump which forces each fluid through the microchip as described.

Nanopak 102 thus simply accepts the eluent and ¹⁸F-fluoride inputs and obviates the need for valves 14 and 18 and all the equipment required for drying the ¹⁸F-fluoride. The output from nanopak 102 is directed to the input port of microfluid device 12. Nanopaks 104 and 106 are able to perform the purification step previously provided by the sep-pak cartridges. Thus, the nanopaks 102, 104 and 106 and the method of the present invention greatly simplify the hardware requirements for the radiotracer synthesis.

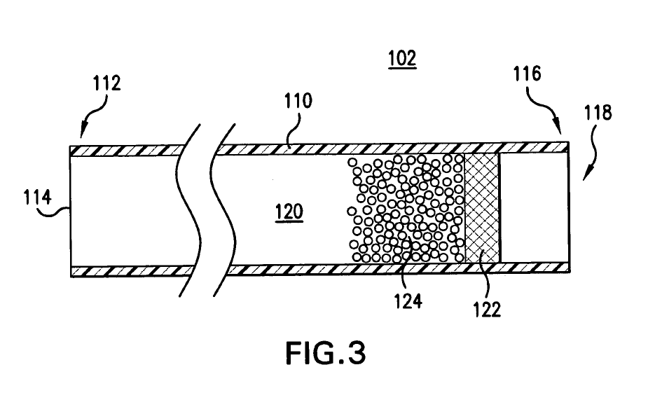

FIG. 3 depicts a nanopak 102 of the present invention. Nanopak 102 (as well as nanopaks 104 and 106) comprises an elongate tubular body 110 having a first end 112 defining an input port 114, a second end 116 defining an output port 118, and defining an elongate passageway 120 extending therebetween. A filter element 122 spans passageway 120. The resin 124 is provided adjacent to filter 122 in passageway 120 (opposite to output port 118). First and second ends 112 and 116 mate with HPLC fittings to provide fluid-tight connection within synthesis system 110.

The volume of resin in the Nanopaks varied from 1-25 μl. Tubes with an inside diameter of 350 μm, 900 μm, and 1.5 mm were investigated. The Nanopaks were filled from a slurry of 5 mg/ml MilliQ-high purity water (18 MΩ) and injected by hand from a syringe. The smaller inside diameter tubings (350 μm and 900 μm) gave higher back pressures that led to problems packing the section with resin. Finally a tubing of ⅛″ outside diameter, 1.5 mm inside diameter, and approximately 6-7 cm long was used. The length of the tubing included the sections necessary for the fittings. The overall length did not vary significantly with the resin volume as the length consumed by the fitting was a large fraction of the overall length. The resin was confined in the tubing by a filter paper (for 1/16″ tubing) or a Vyon (Porvair Plc., Norfolk, U.K.) microporous polyethylene copolymer (for ⅛″ tubing). The Vyon frit material for the ⅛″ tubing was 2.4 mm thick.

The long term limitations of the Nanopak are 1) its inability to become part of a monolithic integrated microfluidic system and 2) the lack of geometric flexibility (i.e. only cylindrical resin columns since the confining structure is the tubing). But they offer the potential to perform very quick trapping and elution experiments were parameters can easily be varied

### Microchips

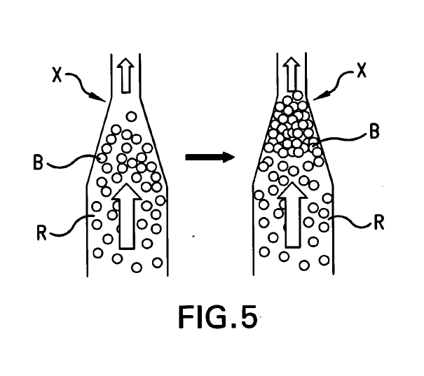

The present invention also contemplates using microfabricated chips to trap the resin beads in a reservoir and deter the beads from leaving it by weirs. Alternative designs, as shown in FIG. 5, do not use weirs to trap the but instead employ beads by a narrowing geometry X at the exit of the reservoir R, which causes a crowding effect that prohibits the beads B from leaving the channel. In some designs only the bead channel for trapping and elution was integrated in other designs mixers for subsequent labeling and deprotection reactions were added. The microchips of the present invention may be formed from suitable glass or polymers, such as COC. The microchips may be formed using a combination of wet-etching of the microstructures in the base and powder blasting of the inlets/outlets through the cover. Using the technique of mask undercutting, weir structures may be formed in the microchannels without the cost of a two-mask structure.

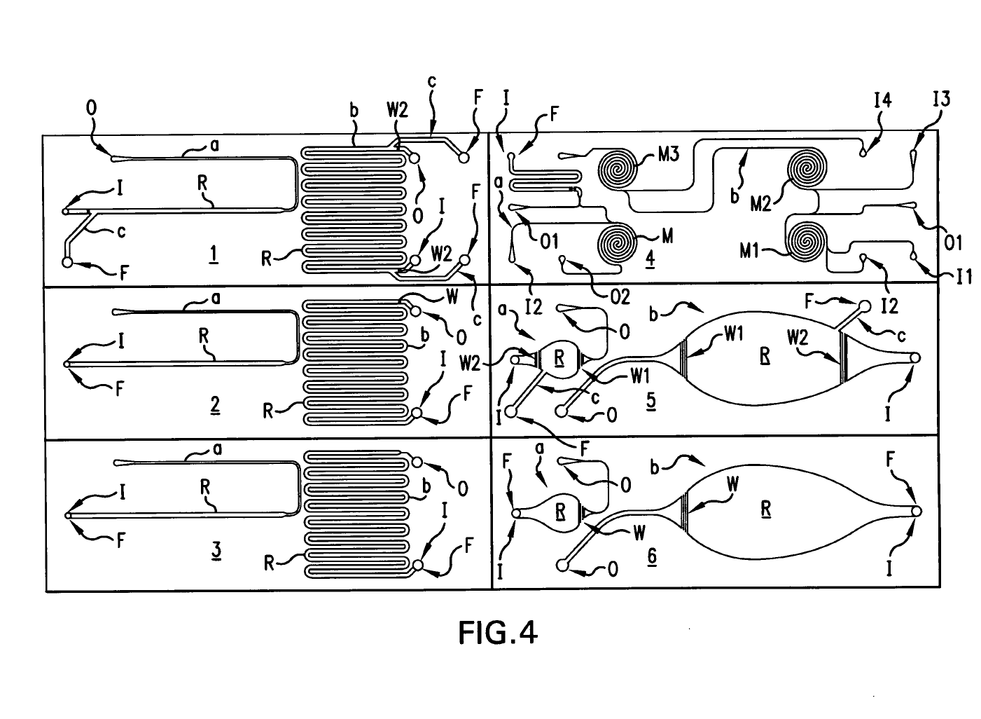

Six variations of a glass chip design are shown in FIG. 4. The chip structures of FIG. 4 are numbered 1-6. Each chip structure includes a first and second microchannel network, referred to as ‘a’ and ‘b’, respectively, where the ‘a’ network is the volumetrically smaller network and the ‘b’ network is the volumetrically larger network of the two. While chips 1-3 and 5-6 may perform the same function of the nanopaks of the present invention, the resin employed in those chips is not shown for clarity of describing the chip structures.

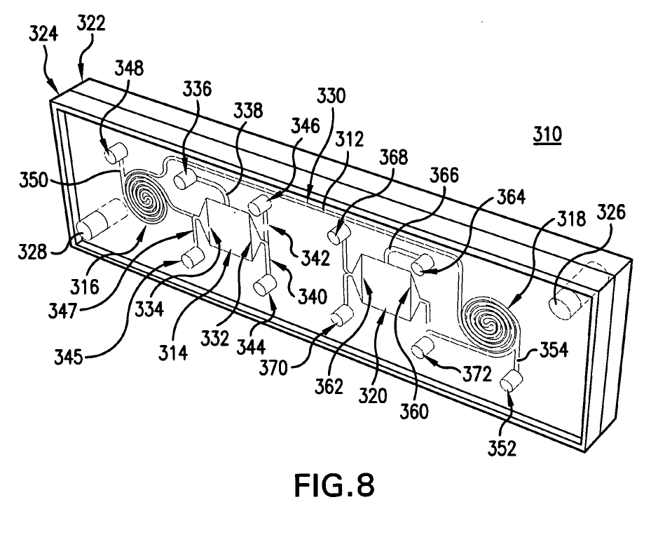

Chips 1-6 are desirably formed by joining two elongate planar bodies along one of their major surfaces. FIG. 8 shows an oblique view of a chip of the present invention to better highlight this construction. The bodies are desirably transparent. The views provided of chips 1-6 are therefore shown looking down upon the chips and through the transparent bodies. Typically, one of the elongate planar bodies defines the fluid transport microchannel pathway of the chip while the other planar body covers over the microchannel pathway to enclose it and thus define the enclosed microchannel network. The covering planar body further defines the input and output ports which are positioned in overlying registry with distinct portions of the microchannel network and allows the various fluids to be provided to or taken from the chip. Additionally, the fluid pressures used to direct fluid through the microchannel network are applied at the various ports. Varying the fluid pressures allows an operator to direct the flow direction and ultimate destination of the fluid directed through the microchannel network.

Chips 1-3 and 5-6 variably include an input port I, an outlet port O, and a fill port F. Each of these chips includes a reservoir R into which the resin is provided through fill port F. Chips 5 and 6 employ tear-shaped reservoirs while chips 1-3 employ straight channel reservoirs. As shown, for channels 2a, 2b, 3a, 3b, 6a, and 6b, the fill port F is co-located with the input port I. For chips 1a, 1b, 5a, and 5b, a fill channel C directly communicates between fill port F and reservoir R, that is, the fill channel enters the reservoir itself. Each inlet port I receives therethrough the ¹⁸F-fluoride output from a cyclotron. The ¹⁸F-fluoride is then directed through the reservoir R to the resin accumulated proximate the respective weirs or channel constrictions. Eluent is then directed through the reservoir R to the outlet O. This ¹⁸F-fluoride mixture is thus ready for further reactions in the mixers of subsequent microchannel chips.

Chip structures 1-3 of FIG. 4 include 1 and 10 μl straight channel designs, labeled ‘a’ and ‘b’, respectively (straight in that the number of turns in the channel is relatively low). Channels 1a, 2a, 3a, and 3b do not employ weirs but instead employ a tapering flowchannel between a relatively wide segment and a relatively narrow segment of the channel as depicted in FIG. 4. Channel 2b incorporates a single weir W at the outlet end of the channel. Channel 1b provides a first weir W1 and a second weir W2 at the inlet and outlet end of the channel, respectively. Channel 1b further includes a second fill port F and fill channel C in direct fluid communication with the reservoir R. The channels and reservoirs have a target depth of 90 microns (+/−10 microns) and the elongate straight segments of the channel have a width between about 90 and 112.5 microns formed by known mask etching techniques.

The chip structures of channels 4a and 4b provide a selection of full system components. Channel 4a provides a 1 μl channel employing a single weir W solid phase extraction channel, for 18F Fluoride concentration, in fluid communication with a micro mixer M, for radiolabelling. Each of the mixers used in the present invention is formed by a channel path which spirals then counter-spirals to make optimum use of the space available on the chip and to provide mixing of two fluids. The output of mixer M of channel 4a is then taken from the chip through the outlet port O to give the option of intermediate processing or analysis. Chip structure 4b provides three micromixers M1, M2, and M3 connected in series with the option to use any or all three at the same time. Fluids would be provided at input ports I1 and I2 and mixed in M1. The output of this reaction may be removed thought output port O1 or it may be directed into second mixer M2 for mixing with another fluid provided through third inlet I3. The output from mixer M2 is then mixed with a fluid directed through fourth inlet I4 for mixing in mixer M3, the product of which is removed at output port O2.

Channels 5a and 5b provide 1 and 10 μl teardrop designs, respectively, employing first and second wiers W1 and W2 at the inlet and outlet ends of the channels. The teardrop reservoirs R are filled with beads through a fill port F and a fill channel C. Channel structures 6a and 6b provide 1 and 10 μl teardrop designs, respectively, employing first wiers W at the outlet ends of the channels. The teardrop reservoirs are filled with beads through the inlet I to the channels.

To fill the glass chips, approximately 1 mm³ of resin particles were suspended in 2 ml of ultrapure HPLC-grade water. The particles were dispersed by ultrasonic agitation for 30 minutes. Sedimentation was used as a crude filtration technique to remove the largest particles, since those would clog the device during filling. The suspension was allowed to settle for 30-45 seconds after removal from the ultrasonic bath. A needle and syringe was then used to withdraw the top 1 ml of water. Ultrapure HPLC-grade ethanol was also investigated as a medium for suspension due to its lower surface energy.

The suspension in the syringe was injected manually into the chip, while observing the filling operation under a microscope. The 1 μl straight designs and 1 μl and 10 μl teardrop designs were filled. For the 10 μl teardrop design, the suspension was also injected into the chip while the chip was immersed in an ultrasonic bath. The 1 μl chips, both straight and teardrop, were filled with resin beads through the chamber inlet or through the separate fill channel, by injecting the suspension of beads in water into the chip. The weirs functioned correctly. The 1 μl straight- and teardrop-designs were filled with 60 μm particles. The weir structures were effective at confining the beads, the inlet did not block during filling and the backpressure was low enough not to require submersed filling in the ultrasonic bath.

For final radiochemistry experiments, the glass devices were interfaced using either a combination of short lengths of PEEK tubing and a chemically resistant epoxy resin, Araldite 2021 (Vantico Ltd., U.K.), or the Micronit Microfluidics 4515 chip holder. In practice, the 10 μl channel structures were not used.

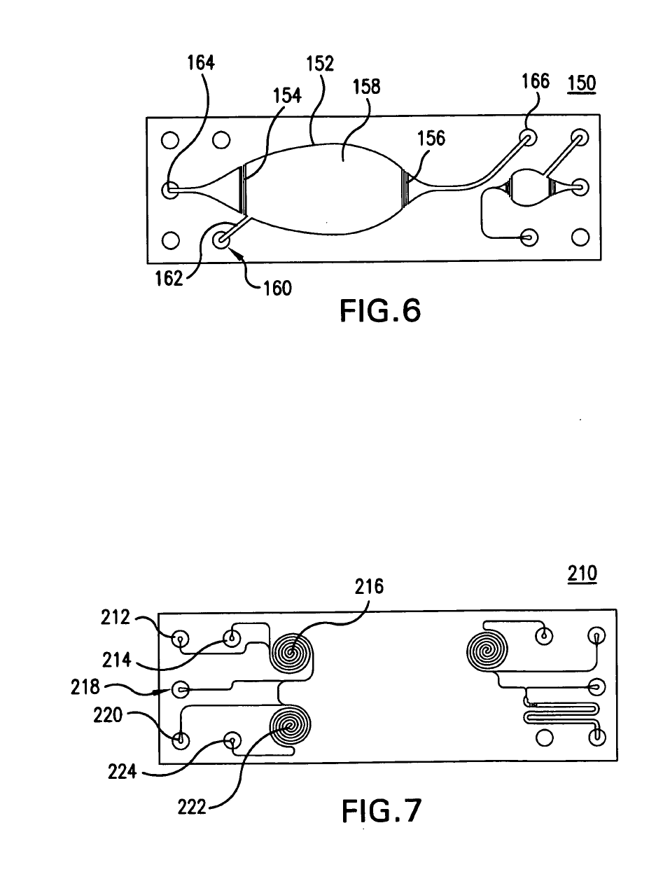

FIGS. 6 and 7 depict microstructures, or microchips, 150 and 210, respectively, of the present invention which may be used in combination to perform the trapping, elution, labeling and deprotection steps. Microchip 150 is the same as microchip 5 from FIG. 4, employing a teardrop shaped channel 152 and first and second weirs 154 and 156. Reservoir 158 is that portion of channel 152 extending between first and second weirs 154 and 156. Loading of resin into reservoir 158 is through a fill port 160 and a filling channel 162 opening in direct fluid communication with the teardrop reservoir 158. After the [18F]Fluoride is trapped on the resin beads in reservoir 158, the eluent is provided through inlet port 164 to flow through channel 152 through to outlet port 166. The eluted [18F]Fluoride may then be directed to microchip 210 of FIG. 7.

FIG. 7 depicts a microchip 210 which receives eluted [18F]Fluoride in inlet 212 and a precursor in inlet 214 to be mixed in a first circuitous microchannel mixer 216 in which labeling takes place. The output from first mixer 216 may be removed from a first outlet port 218 or directed through a second circuitous microchannel mixer 220 in which deprotection takes place. Second inlet port 220 receives another fluid, such as hydrochloric acid, for mixing with in second mixer 222. The outlet port 224 from second mixer 222 provides the unpurified product. The present invention contemplates that purification may be completed using either a nanopak or a microstructure of the present invention as taught for trapping, but in this case such microstructure would provide for the purification of the product.

An alternative material for the microchip structure, PMMA, though not suitable for radiolabeling microstructures since it is not solvent resistant may be used for trapping and elution experiments using the same microchip designs that can later be employed by other structures formed from other material suitable for radiolabeling. Prototype PMMA devices were produced by the lamination of sheets of PMMA with three layers of Scotch double sided adhesive tape (3M, USA) containing the microfluidic channel detail. The microfluidic channels were cut from the middle layer of adhesive tape using a Trotec Speedy CO2 laser cutter (Laserite, U.K.). The top layer would have the inlet and outlet ports cut therethrough to be in overlying registry with the microfluidic channels of the middle layer. Once the three layers were fully assembled, the device could provide the structures such as those shown for channels 1a, 2a, 3a, and 3b of FIG. 4 (ie, those structures lacking wiers). The PMMA devices constructed were interfaced using short lengths of PEEK tubing and a chemically resistant epoxy resin. Laminated microfluidic devices are cheap and simple to fabricate but labour intensive to produce. Channel dimensions of 250 μm wide and 262.5 μm deep led onto bead reservoirs with volumes of 1 to 15 μL and were tested at flow rates of 250 to 1500 μLmin−1. Such devices were able to be packed and used to efficiently trap fluoride (42-90%) with acceptable back pressures. In addition to the 60 μm beads also 100 μm beads have been used for the PMMA devices. Their size distribution was determined to 54 to 134.

Alternatively still, the present invention provides microchips formed from COC. COC will withstand many organics and is radiation resistant. COC has been tested as reaction vessel material for the FASTlab synthesizer. Microfluidic channels for fully integrated FDG production and modular unit testing were produced from cyclic olefin copolymer 6013 (Topas Advanced polymers GmbH, Germany). Microfluidic channels were fabricated by direct micromachining using a 0.3 mm HSS end mills (Toolex, Somerset, U.K.) on a Datron M6 CNC machine running Excalibur CAD/CAM software (Datron, Buckinghamshire, U.K.) by D4 Technology Ltd., (Hampshire, U.K.). The channels were sealed by thermal diffusion bonding. COC devices were investigated as part of this investigation due to the solvent resistance of the material and the case of fabrication. Devices produced externally costing £15 to £40 per device. COC has the additional advantage of lending itself to injection moulding and therefore mass production for the fabrication of disposable devices. COC microchips have been developed integrating the whole experimental setup plus SPE purification onto a single chip.

FIG. 8 depicts a microchip 310 which functions as a full synthesis system formed from COC, with mixers and 10 μl resin chambers. The COC integrated microchip 310 provides a microchannel 312 having a first resin chamber, or reservoir, 314 for 18F phase transfer, a labelling reactor 316, a deprotection reactor 318, and a second resin chamber, or reservoir, 320 for purification. Microchip 310 includes a first elongate planar body 322 and a second elongate planar body 324. Each of bodies 322 and 324 are formed by transparent COC so that the internally-located microchannel 312 appears visible in this view. Bodies 322 and 324 may be mechanically located by pins 326 and 328 extending through both bodies so as to ensure the placement of the two bodies with respect to each other. Body 322 defines an open-topped microchannel pathway 330 which, when mated to body 324, forms the enclosed (except for the inlet and outlet ports) microchannel 312. Body 324 defines all of microchip 310's inlet and outlet ports therethrough so that each is positioned in overlying registry with portions of microchannel pathway 330 so as to enable the introduction or removal of a fluid into or out of microchannel 312. Bodies 322 and 324 are held together so as to prevent fluid leakage out from microchannel 312.

First and second weirs 332 and 334 are formed in first body 322 to extend across microchannel 312 to either side of first reservoir 314. Fill port 336 is defined through second body 324 and a fill channel 338 extends in fluid communication between first reservoir 314 and fill port 336. Resin is delivered into first reservoir 314 through fill port 336 and fill channel 338. First and second inlet channels 340 and 342 are provided opposite first weir 332 from reservoir 314 so as to extend in fluid communication out to first and second inlet ports 344 and 346 respectively. For example, [18F]Fluoride may be provided through first inlet port 344 and an eluent would be provided through second inlet port 346 for both to flow into first reservoir 314. The eluted [18F]Fluoride reaches microchannel 312 opposite second weir 334 from first reservoir 314.

Second body 324 of microchip 310 further defines a third inlet port 345 in fluid communication with microchannel 312 via a precursor flow channel 347 extending in fluid communication therebetween. The junction of precursor flow channel 347 and microchannel 312 is at a location between reservoir 314 and labeling reactor 316. Precursor delivered through third inlet port 347 mixes with the eluted [18F]Fluoride from first reservoir 314 and is further mixed therewith as both flow through labeling reactor 316. Labeling reactor 316 is a portion of microchannel 312 that provides a spiraling and counter-spiraling flowpath to ensure full mixing of the precursor with the eluate so as to perform the labeling step of the synthesis method.

Second body 324 of microchip 310 also defines a fourth inlet port 348 in fluid communication with microchannel 312 via a segment 350 extending in fluid communication therebetween. Segment 354 communicates with microchannel 312 at a location beyond between labeling reactor 316 and deprotection reactor 318. Fourth inlet port 348 may be used either to introduce a deprotection agent, if so desired, or to remove the fluorinated fluid after labeling. Deprotection occurs in deprotection reactor 318. Deprotection reactor 318 is a portion of microchannel 312 that provides a spiraling and counter-spiraling flowpath to ensure full mixing of the labeled [18F]Fluoride so as to perform the deprotection step of the synthesis method. The output from deprotection reactor 318 may be directed either to second reservoir 320 or out from microchip 310 via segment 354 to fifth inlet port 356.

Third and fourth weirs 360 and 362 extend across microchannel 313 so as to define second reservoir 320 therebetween. Fill port 364 is defined through second body 324 and a fill channel 366 extends in fluid communication between second reservoir 320 and fill port 364. Resin is delivered into second reservoir 320 through fill port 364 and fill channel 366. The resin in second reservoir 320 provides for purification of the deprotected [18F]Fluoride solution as it flows past fourth weir 362 towards either of outlet ports 368 or 370. An additional port 372 is provided in fluid communication with microchannel 312 upstream of second reservoir 320 should it be desired for providing additional eluent for the purification step. Outlet ports 368 and 370 allow for alternate conducting of the eluate from second reservoir 320 to alternate destinations as desired.

### SPE Separation Without Additional Drying

In order to keep the water content of the post elution fluoride solution low enough to ensure proper labeling, the following strategy is used:
(1) After trapping ¹⁸F-fluoride on the resin it is eluted with a carbonate/K222/water/acetonitrile solution that contains just enough water to enable complete elution of the fluoride. It is expected that the amount of water required for this lead to a too high water concentration for labeling
(2) For this reason the eluted liquid is diluted with further acetonitrile. As starting point the water concentration in this “final fluoride solution” is kept ≦0.5%

For the following experiments, the following terminology is used:

Carbonate solution denotes potassium carbonate dissolved in water.

Eluent denotes the above carbonate solution plus acetonitrile with dissolved Kryptofix in a stoichiometric concentration matching the used carbonate concentration.

Final fluoride solution denotes the eluent plus additional acetonitrile that is added after elution to keep the water concentration low enough for subsequent labeling.

The above procedure shall be optimized for trapping efficiency of the ¹⁸F-fluoride (Goal: 90% to 100%), elution efficiency (Goal: 90% to 100%), speed of the whole procedure, and the maximum labeling yield (that is not effected by water content of the fluoride solution). Several parameters are expected to be relevant for trapping and elution of ¹⁸F-fluoride and for thus optimizing this procedure. Namely, the amount of trapping resin, the water concentration of eluent, the carbonate content of eluent, the flow speed for trapping, the flow speed for elution, and the volume of the eluent are all parameters to be balanced and optimized.

The amount of trapping resin dictates that more resin will trap more efficiently but will also require more eluent volume. A higher water concentration in the eluent will elute more efficiently but will also degrade the labeling yield. More carbonate content in the eluent is expected to elute more effectively, but the limited water content of the eluent will limit solubility of the Carbonate. A lower flow speed for trapping will trap more effectively but result in a loss of activity due to a rise in decay. Similarly, a lower elution speed will elute more effectively but result in a loss of activity due to a rise in decay. Finally, a higher eluent volume will elute more effectively but will increase the duration of elution and of all subsequent steps, resulting in activity loss by decay.

It is expected that most of the above parameters do not act independent of each other. So for a complete investigation all of the parameters have to be varied by keeping the other parameters constant. An intuitive strategy that focused on the most critical parameters was employed, whereby the resin volume and water concentration in the eluent were investigated.

### Experiment 1—

### ¹⁸F-Fluoride Production

A GE PETtrace cyclotron with a silver target (GE P52310JL) equipped with a Havar 50 μm foil with a volume of 0.8 ml has been used. The ¹⁸O source is 97% ¹⁸O enriched water from Rotem Industries Ltd. diluted by 20 to 30% with water.

### Solid Phase Extraction

Filling of the resin into a nanopak tube was conducted as described above. For trapping an aliquot of ¹⁸O-water containing ¹⁸F-fluoride equivalent to approximately 0.5 mCi was made up to a total volume of 1 mL by the addition of ultrapure water and passed through the device at a variety of flow rates from 100 to 1500 μLmin-1 using a PHD 2000 syringe pump (Harvard Apparatus, Kent, U.K.). Starting activity, trapped activity and experimental losses were measured using an IG12 ion chamber and plotted as percentage trapped without decay correction unless otherwise stated.

### Macroscale Radiolabeling of Mannose Triflate

Macroscale synthesis of [¹⁸F]Tetraacylated glucose (FTAG) and 2-deoxy-2-[¹⁸F]fluoro-d-glucose (FDG) was performed to allow comparison between conventional macroscale methods, both with and without azeotropic drying and microfluidic solid phase extraction methods.

[¹⁸F]Tetraacylated Glucose (FTAG)

To 1 mL of aqueous ¹⁸F-fluoride (0.5 mCi) was added 0.3 mL (0.1M) K2CO3 (0.06 mM K⁺), 0.7 mL acetonitrile, 26 mg K222 (0.07 mM), and heated to 120° C. for approx. 5 minutes with a stream of N₂ gas to aid azeotropic drying. After drying, the vessel was cooled to 85° C. and 20 mg mannose triflate in 0.5 mL anhydrous acetonitrile was added and held at 85° C. for 10 minutes resulting in a radiochemical purity of 72-90% (n=3). The above reaction performed without azeotropic drying led, as expected, to a drop in radiochemical purity of FTAG to 5-6% (n=2).

2-deoxy-2-[¹⁸F]fluoro-d-glucose (FDG)

FDG is prepared through the deprotection of FTAG by base hydrolysis and was performed by the addition of 0.3 mL (0.3M) sodium hydroxide to the cooled (<40° C.) reaction vessel. Hydrolysis occurs with good mixing in approximately 1 minute with a radiochemical purity of at least 80%.

Yield Determination

The total yield of a labeling reaction is limited by the yield of the labeling reaction itself, i.e. how much of the ¹⁸F-fluoride reacts with the precursor and by secondary losses like radioactive decay or trapping of radioactivity in the synthesis system. If the later factors can be neglected the yield is totally determined by the reaction yield and can be measured by determining the radiochemical purity (RCP). Radiochemical purity is defined by the radioactivity of the product molecule divided by the radioactivity of all other ¹⁸F species (unreacted ¹⁸F-fluoride and site products).

Since the secondary losses are considered to be constant in all experimental series RCP is used in many experiments to look for yield dependence on several parameters. In some experiments the total yield was measured directly by comparison of starting activity and product activity of each step of a synthesis as determined by an IG12 ion chamber without decay correction unless otherwise stated.

Radiochemical purity was established by analytical radio-HPLC using radioactivity detection (Bioscan, Flow count FC-3300-NaI/PMT). Sample injections were performed using a Rheodyne 8125 injector fitted with a 20 μL sample loop into a Nucleosil 10 μm, NH2, 100 Å, 250×4.6 mm column (Phenomenex, U.K.) running a mobile phase of 60% acetonitrile, 40% aqueous 0.1M pH7 phosphate buffer at 2 mlmin-1. Comparison of peak areas was performed by radio-HPLC software (Laura v1.4a, Lablogic, U.K.) running on a Compaq Prolina PC.

### Experiment 1—Results

### Resin Volume Required for Efficient Fluoride Trapping

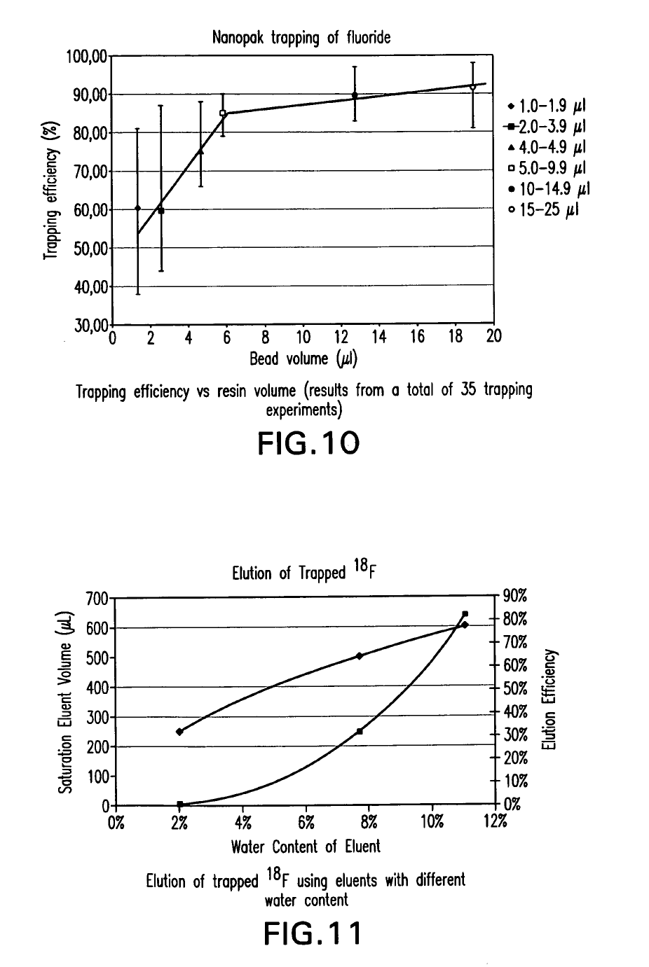

In order to investigate the use of small quantities of solid phase resin for the extraction of ¹⁸F-fluoride, the devices described herein were fabricated as described and filled with between 1 and 25 μL of the resin. From FIG. 10 (Trapping Efficiency) graph it can be seen that although good trapping efficiency can be achieved with very small quantities of beads, the trapping efficiency exhibits a large degree of variability. The results of FIG. 10 are averages of 35 experiments; however some outliers have been removed for clarity. Efficient ¹⁸F-fluoride trapping of 1 mL irradiated ¹⁸O-water requires a minimum resin volume of 5 μL. It has been found that 10 μL of resin is sufficient to trap Fluoride from 1 mL of irradiated ¹⁸O-water.

Fluoride Elution from Small Resin Volumes

Subsequently, as shown in FIG. 11, it was determined that a water content of 11% is sufficient to elute 18F efficiently from 10 μL of resin.

### Suitability of the Used Eluent for Radiolabeling

It was then determined that eluents containing 5 μL of 0.1M K₂CO₃ per 0.5 ml of acetonitrile and K222 are suitable for FTAG and FDG synthesis. To ensure reproducible elution with larger volume (>10 μL) Nanopaks, the quantity of water was increased to 10 μL and the volume of acetonitrile increased accordingly to maintain a total water conc. of 0.5% in the reaction mixture and a total reaction volume of 2 mL. Subsequent elution of five Nanopaks with bead volumes of 10.8-15.7 μL with 10 μL of 0.10 M solution in 1 ml acetonitrile gave elution of 72-89% (n=5).

It was thus determined that suitable conditions for efficient trapping, elution and FDG synthesis without azeotropic drying with equal volumes of eluent and precursor solution could be achieved using 10-15 μL of resin with 1 mL eluent containing 99% acetonitrile+1% of 0.1M K₂CO₃ in water and 1 mL precursor in acetonitrile added for labeling (reducing water content to 0.5%).

### Experiment 2

This experiment investigated the integration of the full synthesis process on a single chip.

Test of the Elution Method with Microfluidic Synthesis

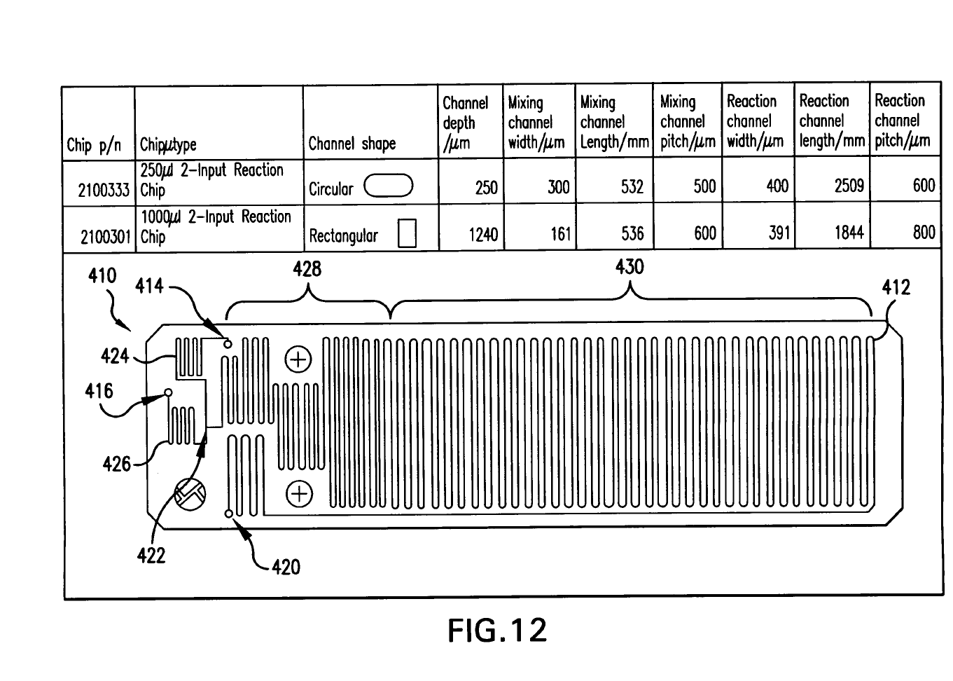

First FDG microsynthesis experiments utilize a Nanopak and a commercial glass mixer chip 410 for labeling (Africa micro reactor, Syrris Ltd., Hertfordshire, U.K.). The geometry of chip 410 is shown in FIG. 12. Chip 410 is formed by joining a first and second elongate planar glass bodies together as previously described, which define an elongate microchannel 412 therebetween. FIG. 12 provides specific dimension criteria for chip 410. Chip 410 provides a first input port 414, a second input port 416, and an output port 418 at the opposite end of channel 412 from input ports 414 and 416. Input ports 414 and 416 are in fluid communication with a mixing junction 420 via segments 422 and 424, respectively. Microchannel 412 includes a first serpentine mixing segment 426 and a second serpentine reaction segment 428 extending serially between junction 420 and output port 418.

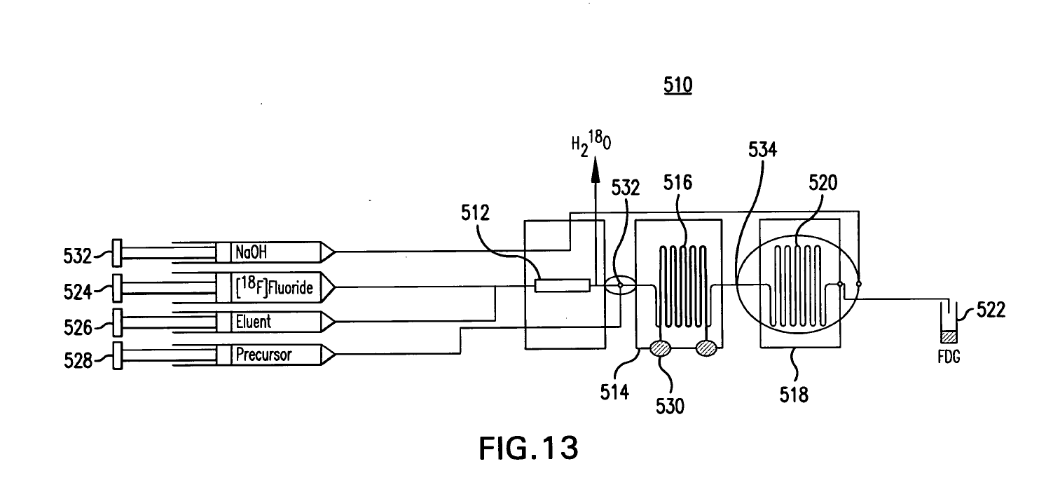

FIG. 13 depicts a schematic of synthesis system 510 used in the experiment. A nanopak 512 connected with a first chip 514 having a microchannel 516 for performing the labeling reaction and a second chip 518 having a microchannel 520 for performing the deprotection step. The unpurified output from chip 518 is collected in vial 522. Nanopak 512 receives both ¹⁸F-fluoride and eluent from sources 524 and 526, respectively. The eluted ¹⁸F-fluoride is mixed with a precursor fluid from precursor source 528 and forced through microchannel 516 for labeling. A heater 530 provides heat to chip 514 for the labeling reaction. The labeled output from chip 514 is then mixed with NaOH from source 532 at a junction 534 located intermediate of chips 514 and 518 and all is forced through microchannel 520 for deprotection. The unpurified output from chip 518 is conducted to vial 522. Table 2 gives specifics of the experiments.

Chips 514 and 518 were 1000 μL dual input glass reaction chips made by Syrris. Nanopak 512 was formed from a length of Teflon tube and contained 15 μL of Chromafix PS-HCO3 (from Macherey Nagel) resin with a 60 μm bead size. The starting activity was between 0.4 and 1 mCi, with labeling tested up to 1 Ci. Heater 530 provided a labeling temperature of 85° C. The flow rate for trapping was 1000 μL/min while the reaction flow rate was 250 μL/min. Radiochemical purity, without purification was 80%, as measured by HPLC.

¹⁸F-Fluoride from 1 mL of ¹⁸O-water was trapped on Nanopaks. The fluoride was subsequently eluted with K222/K₂CO₃ and mixed with a mannose triflate in acetonitrile solution on the microfluidic device at elevated temperature. The mixture was collected at room temperature and subjected to HPLC analysis after a total process time of 11 minutes. Results are summarized in Table 1 below.

TABLE 1

| | Trapping | Elution | Labeling | Deprot | Total |
|---|---|---|---|---|---|
| Duration | 1 min | 4 min | 4 min | 2 min | 11 min |
| Uncorrected Yield | 88% | 83% | 23%** | 98%* | 17% |

*Expected, not yet measured
**Not optimized. Main limit is 18F- loss on the glass surface. For checking this hypothesis, adsorbtion loss has been measured to be about 80% and labelling has been performed in a conventional recator using the same reaction solution as in the glass chip. This synthesis gained an uncorrected labelling yield of 60% and a total yield of 43%.

FDG synthesis has thus been performed on microdevices including SPE phase transfer, omitting the common azeotropic drying step. The unoptimized duration for starting with 1 mL irradiated 18O water and activities up to 1 Ci is 11 minutes. This duration can be reduced if only a single patient dose shall be synthesized starting with 0.1 mL 18O water. If 18F− adsorption on the glass surface of the microreactor can be avoided, e.g. by using COC as device material, a total uncorrected yield of approximately 65% can be expected with further optimization potential. Application to radiosynthesis of other 18F tracers is possible if the water tolerance of the labeling step is similar to FDG.

Additionally, as part of the synthesis process, microfluidic implementation of the solid phase extraction phase-transfer method has been developed. Phase transfer of 1 mL of ¹⁸O-water by microlitre volume of resin with process times about 5 minutes achieved trapping and elution yields about 90%.

An eluent with low water content has been used so that after addition of the acetonitrile based precursor solution water concentration in the reaction solution is only 0.5% and no additional drying step is required. This allows the use of a very simple microstructure. It has been checked that this phase transfer method is working well for FDG synthesis by “classical” and microfluidic synthesis experiments. In contrast to the classical synthesis the microfluidic synthesis had a rather low yield. Investigations revealed that this is caused by ¹⁸F loss due to adsorption on the surface of the used glass chip and it is expected that this loss can be avoided by using another material instead of glass. An integrated microfluidic synthesis system including all synthesis steps but final purification is currently been manufactured based on COC. Such a system is expected to perform FDG synthesis in 17 minutes with an uncorrected yield of approx. 54%.

The only synthesis step not implemented on a microstructure so far is final purification which has not yet been performed. Some ¹⁸F tracers, such as FDG, FMISO, or FACBC, can be purified by solid phase extraction. Since this is the same technology as used in the study for the phase transfer step, extension to this type of purification is relatively straight-forward. That is, the present invention contemplates that the purification step may be accomplished by use of a nano-pack or a microchip of the present invention which is produced for that purpose. The majority of other tracers require HPLC purification which would have to be implemented on a microstructure that likely would need, for economic reasons, to be reusable.

The phase transfer method of the present invention can produce fluoride solutions which may be used for any subsequent nucleophilic radiofluoridation process.

As microstructure material for an integrated system COC is the preferred material although other materials may be deemed suitable for a particular purpose. COC has the required resistance against organic solvents and radiation. It also can be expected to be safe in terms of leachables. Since COC microstructures can be produced by injection moulding mass production is expected to be economical. For special applications requiring higher temperatures glass should be kept in mind as alternative material.

While the particular embodiment of the present invention has been shown and described, it will be obvious to those skilled in the art that changes and modifications may be made without departing from the teachings of the invention. The matter set forth in the foregoing description and accompanying drawings is offered by way of illustration only and not as a limitation. The actual scope of the invention is intended to be defined when viewed in its proper perspective based on the prior art.

What is claimed is:

1. A method for [¹⁸F]fluoride phase transfer, said method comprising the steps of:
trapping [¹⁸F]fluoride on a resin held within a microfluidic chamber;
eluting the [¹⁸F]fluoride with an eluent to form an eluate, and
optionally diluting the water concentration of said eluate to form a final [¹⁸F]fluoride solution.

2. The method of claim 1, wherein said eluent comprises potassium carbonate dissolved in water.

3. The method of claim 2, wherein said eluent further comprises acetonitrile and Kryptofix in a stoichiometric concentration matching the used carbonate concentration.

4. The method of claim 3, wherein said diluting step further comprises adding additional acetonitrile to said eluate.

5. The method of claim 1, wherein the water concentration of said final [¹⁸F]fluoride solution is between 0.1% and 0.7%.

6. The method of claim 1 wherein the water concentration of said final [¹⁸F]fluoride solution is ≦0.5%.

7. The method of claim 1, wherein said eluting step is performed using enough water to enable complete elution of the [¹⁸F]fluoride.

8. The method of claim 1, wherein said trapping step is performed using a (nanopak)(microchip).

9. The method of claim 1, wherein said resin is a functionalized polystyrene.

10. The method of claim 9, wherein said resin includes a bead size of about 60 microns in diameter.

11. A method for [¹⁸F]radiotracer synthesis comprising the steps of:
trapping [¹⁸F]fluoride on a resin held within a microfluidic chamber;
eluting the [¹⁸F]fluoride with an eluent to form an eluate;
optionally diluting the water concentration of said eluate to form a final [¹⁸F]fluoride solution; followed by
reacting said final [¹⁸F]fluoride solution with a labelling precursor to form an [¹⁸F]radiotracer.

12. A method of claim 11, wherein said trapping, eluting, and reacting steps are performed using a microchip for performing nucleophilic fluoridation phase transfer, said microchip comprising:
a microchip body comprising a first and second elongate body joined along a major surface of each said body;
an elongate microchannel defined between said first body and second bodies;
a first input port defined by said first body extending therethrough in fluid communication with said microchannel,
a first output port defined by said first body extending therethrough in fluid communication with said microchannel; and
a reservoir defined by an elongate portion of said microchannel at a location between said first input port and said first output port, wherein said resin is retained within said reservoir.

13. A method according to claim 12 wherein the reaction of said final [¹⁸F]fluoride solution with a labelling precursor to form an [¹⁸F]radiotracer comprises the following steps:
reaction of said final [¹⁸F]fluoride solution with a labelling precursor;
optional removal of any protecting groups; and
purification of the resultant [¹⁸F]radiotracer.

14. A method according to claim 12 wherein at least one of said labeling, deprotecting, and purifying steps is performed within a microfluidic device.

15. A method according to any one of claims 12 to 14 wherein all steps are performed within a single microfluidic device.

16. A method according to any one of claims 12 to 15 wherein the labelling precursor is mannose triflate and the [¹⁸F]radiotracer is [¹⁸F]FDG.

17. A device for performing [¹⁸F]fluoride phase transfer, comprising:
An elongate tubular body having a first open end defining an entry port, a second open end defining an exit port, said tubular body defining an elongate reservoir extending in fluid communication between said entry and exit ports;
A filtration device spanning said reservoir adjacent said exit port; and
A resin positioned in said reservoir opposite said filtration device from said exit port, said resin sized to be retained within said reservoir by said filtration device.

18. A device of claim 17, wherein said filtration device comprises filter paper.

19. A device of claim 17, wherein said filtration device comprises a microporous copolymer.

20. A device of claim 17, wherein said resin comprises a functionalized polystyrene.

21. A device of claim 20, wherein said resin includes a bead size of about 60 microns in diameter.

22. A device of claim 17, wherein said tubular body is formed of Teflon.

23. A microchip for performing nucleophilic fluoridation phase transfer comprising:
a microchip body comprising a first and second elongate body joined along a major surface of each said body;
an elongate microchannel defined between said first body and second bodies;
a first input port defined by said first body extending therethrough in fluid communication with said microchannel,
a first output port defined by said first body extending therethrough in fluid communication with said microchannel;
a reservoir defined by an elongate portion of said microchannel at a location between said first input port and said first output port; and
a resin retained by said microchip body within said reservoir.

24. A microchip of claim 23, further comprising a first fill port defined by said first body and extending therethrough and a first channel segment defined between said first and second bodies extending in fluid communication between said second input port and said reservoir, said second input port and said first channel segment sized to allow passage of said resin therethrough into said reservoir.

25. A microchip of claim 24, wherein said microchip body retains said resin in said reservoir by defining a constriction at one end of said reservoir.

26. A microchip of claim 25, further comprising a first weir at said one end of said reservoir.

27. A microchip of claim 26, further comprising a second weir at the other end of said reservoir.

28. A microchip of claim 23, wherein at least a portion of said microchannel extends along a serpentine path.

29. A microchip of claim 23, further comprising a second fill port defined by said first body and extending therethrough and a second channel segment defined between said first and second bodies extending in fluid communication between said second fill port and said reservoir, said second port port and said second channel segment sized to allow passage of said resin therethrough into said reservoir.

30. A microchip of claim 23, wherein said reservoir further comprises an elongate straight segment of said microchannel.

31. A microchip of claim 23, wherein said reservoir further comprises a tear-shaped segment of said microchannel such that the width of said microchannel varies along the length of said reservoir.

32. A system for performing nucleophilic fluoridation phase transfer and labeling comprising:
(a) a trapping device for performing [¹⁸F]fluoride phase transfer, said traping device comprising:
an elongate tubular body having a first open end defining an entry port, a second open end defining an exit port, said tubular body defining an elongate reservoir extending in fluid communication between said entry and exit ports;
a filtration device spanning said reservoir adjacent said exit port;
a resin positioned in said reservoir opposite said filtration device from said exit port, said resin sized to be retained within said reservoir by said filtration device;
(b) a microchip for performing labeling, said microchip comprising
a microchip body comprising a first and second elongate body joined along a major surface of each said body;
an elongate microchannel defined between said first body and second bodies;
a first input port defined by said first body extending therethrough in fluid communication with said microchannel,
a first output port defined by said first body extending therethrough in fluid communication with said microchannel,
and
(c) an elongate hollow conduit extending between said exit port of said trapping device and said first input port of said microchip.

33. A system of claim 32, wherein said microchannel further comprises at least one segment extending along a spiraling path.

34. A microchip of claim 33, where said microchannel further comprises at least one segment extending along a counter-spiraling path.

35. A microchip for performing nucleophilic fluoridation phase transfer and labeling comprising:
a microchip body comprising a first and second elongate body joined along a major surface of each said body;
an elongate microchannel defined between said first body and second bodies;
a first input port defined by said first body extending therethrough in fluid communication with said microchannel,
a first output port defined by said first body extending therethrough in fluid communication with said microchannel;
a reservoir defined by an elongate portion of said microchannel at a location between said first input port and said first output port; and
a second input port defined by said first body extending therethrough in fluid communication with said microchannel at a junction between said reservoir and said output port;
wherein said microchannel includes a mixing segment extending between said junction and said output port.

36. A microchip of claim 35, further comprising a resin retained by said microchip body within said reservoir.

37. A microchip of claim 35, further comprising a third input port defined by said first body extending therethrough in fluid communication with said microchannel at a location between said first input port and said reservoir.

38. A microchip of claim 35, further defining a first fill port defined by said first body extending therethrough in direct fluid communication with said reservoir.

39. A microchip of claim 35, wherein said mixing segment further comprises a spiral-counterspiral flowpath.

40. A microchip for performing nucleophilic fluoridation labeling and deprotection comprising:
a microchip of claim 35, wherein said microchip further comprises
a second mixing segment of said microchannel at a location between said mixing segment and said output port; and
a fourth input port defined by said first body and extending therethrough in fluid communication with said microchannel at a location between said mixing segment and said second mixing segment.

41. A microchip for performing nucleophilic fluoridation phase transfer, labeling, deprotection and purification, comprising:
a microchip of claim 39, wherein said microchip further comprises
a second reservoir defined by an elongate portion of said microchannel at a location between said second mixing segment and said first output port; and
a fifth input port defined by said first body and extending therethrough in fluid communication with said microchannel at a location between said second mixing segment and said second reservoir.

42. A microchip of claim 41, further comprising a second output port defined by said first body and extending therethrough in fluid communication with said microchannel at a location between said second reservoir and said first output port.

43. A microchip of claim 42, further comprising a first weir extending across said reservoir at one end thereof.

44. A microchip of claim 43, further comprising a second weir extending across said reservoir at the other end thereof.

45. A microchip of claim 42, further comprising a first weir extending across said second reservoir at one end thereof.

46. A microchip of claim 45, further comprising a second weir extending across said reservoir at one the other end thereof.

47. A microchip of claim 35, wherein said second input port is in fluid communication with a source of precursor.

48. A system for performing nucleophilic fluoridation labeling and deprotection comprising:
a microchip of claim 35;
a resin retained by said microchip body within said reservoir;
a source of 18F in fluid communication with said first end of said reservoir;
a source of eluent in fluid communication with said first end of said reservoir and
a source of precursor in fluid communication with said second input port.

49. A microchip for performing nucleophilic fluoridation labeling and deprotection comprising:
a microchip of claim 40;
a resin retained by said microchip body within said reservoir;
a source of 18F in fluid communication with said first end of said reservoir;
a source of eluent in fluid communication with said first end of said reservoir;
a source of precursor in fluid communication with said second input port; and
a source of a deprotection agent in fluid communication with said fourth input port.

50. A system for performing nucleophilic fluoridation fluoridation phase transfer, labeling, deprotection and purification, comprising:
a microchip of claim 41;
a resin retained by said microchip body within said reservoir;
a source of 18F in fluid communication with said first end of said reservoir;
a source of eluent in fluid communication with said first end of said reservoir;
a source of precursor in fluid communication with said second input port;
a source of a deprotection agent in fluid communication with said fourth input port;
a source of a second eluent in fluid communication with said fifth input port.

51. A microchip of claim 23, wherein:
said first body is further comprised of a first and second layer, wherein said first layer defines a pathway for said microchannel, such that said microchannel is defined between second layer and said second body.

52. A microchip of claim 51, wherein said first layer, second layer and said first body further comprise a sheet of PMMA.
